(19) United States
(12) Patent Application Publication
(10) Pub. No.: US 2025/0293370 A1
(43) Pub. Date: Sep. 18, 2025

(54) BODY-INTEGRATED VEHICLE BATTERY BOX SUB ASSEMBLY

(71) Applicant: Fisker Inc., Manhattan Beach, CA (US)

(72) Inventor: Steven Atkins, London (GB)

(21) Appl. No.: 18/604,124

(22) Filed: Mar. 13, 2024

(51) Int. Cl. H01M 50/244; B60L 50/64; H01M 50/204; H01M 50/242; H01M 50/249

(52) U.S. Cl. CPC H01M 50/244; B60L 50/64; H01M 50/204; H01M 50/242; H01M 50/249

(57) ABSTRACT

The technology disclosed herein enables integration of a battery box sub assembly into the body of an electric vehicle. In a particular example, an apparatus includes a left side sill for the vehicle and a right side sill for the vehicle. The apparatus further includes a front casting affixed to a front end of the left side sill and a front end of the right side sill and a rear casting affixed to a rear end of the left side sill and a rear end of the right side sill. The left side sill, the right side sill, the front casting, and the rear casting form a cavity into which one or more battery modules fit. The apparatus also includes a thermal management plate positioned on top of the cavity.

### BACKGROUND

A paradigm shift in vehicle design and construction occurred when traditional body-on-frame architectures, once prevalent, are now giving way to unibody structures. Unibody construction integrates the vehicle's body and frame into a single, cohesive structure. Unlike body-on-frame designs, which consist of a separate ladder-like frame and body panels, unibody vehicles rely on a unified framework. Some key advantages of unibody architectures include weight reduction, enhanced safety, improved ride quality, and space optimization. Unibody designs are inherently lighter than body-on-frame counterparts. By eliminating the heavy frame, manufacturers achieve weight savings, leading to improved efficiency and handling dynamics. Unibody vehicles further distribute crash forces across the entire structure, reducing the risk of cabin deformation during collisions. Rigidity and energy absorption are superior, enhancing occupant safety. The absence of frame joints minimizes vibrations and noise, resulting in a smoother ride. Unibody vehicles exhibit better torsional stiffness, contributing to precise handling. Unibody platforms also allow for creative interior layouts, maximizing passenger and cargo space.

Modern electric vehicles have adopted a unique skateboard architecture that optimizes space utilization for incorporating high-voltage battery packs into a unibody vehicle. In the skateboard layout, the battery pack occupies most, if not all, of the under floor space between the vehicle's axles. Using the under floor space minimizes the impact a large battery pack may have on passenger and utility space within the vehicle. It also enables a low center of gravity, which enhances stability and handling. One or more electric motors are positioned within or between the wheel hubs at each axle, eliminating the need for a bulky engine and freeing up space for other uses. This arrangement optimizes weight distribution and traction. Batteries, motors, and other systems can be easily swapped or upgraded, simplifying maintenance, and future-proofing the vehicle.

When unibody vehicles adopt the skateboard architecture, they combine the structural integrity of unibody construction with the space-efficient, modular features of the skateboard. The vehicle includes a unibody chassis resembling a skateboard, with the battery pack and electric motors neatly integrated. On top of this chassis, a body structure can be built. This approach allows for cost-effective variations in vehicle size, from small consumer cars to luxury models, delivery trucks, and off-road vehicles-all using variants of the same skateboard platform. However, space in the unibody structure is needed for insertion of a pre-assembled battery pack into the skateboard architecture and the battery pack is typically affixed to the structure by mechanical means (e.g., bolted). The typical battery pack installation, therefore, compromises the structural advantages of unibody construction.

### SUMMARY

The technology disclosed herein enables integration of a battery box sub assembly into the body of an electric vehicle. In a particular example, an apparatus includes a left side sill for the vehicle and a right side sill for the vehicle. The apparatus further includes a front casting affixed to a front end of the left side sill and a front end of the right side sill and a rear casting affixed to a rear end of the left side sill and a rear end of the right side sill. The left side sill, the right side sill, the front casting, and the rear casting form a cavity into which one or more battery modules fit. The apparatus also includes a thermal management plate positioned on top of the cavity.

In another example, a method includes feeding coolant fluid into an inlet of a front casting of a battery box sub assembly for the vehicle. The battery box sub assembly includes a left side sill for the vehicle and a right side sill for the vehicle. The assembly also includes the front casting affixed to a front end of the left side sill and a front end of the right side sill and a rear casting affixed to a rear end of the left side sill and a rear end of the right side sill. The left side sill, the right side sill, the front casting, and the rear casting form a cavity into which the one or more battery modules fit. The assembly further includes a thermal management plate positioned on top of the cavity into which the coolant fluid flows after passing through the inlet. The method also includes receiving the coolant fluid from an outlet of the front casting after flowing through the thermal management plate.

In another example, an electric vehicle includes a battery box sub assembly, a right bodyside affixed to the battery box sub assembly, a left bodyside affixed to the battery box sub assembly, a front subframe affixed to the battery box sub assembly, and a rear subframe affixed to the battery box sub assembly. The battery box sub assembly forms a cavity for one or more battery modules of the electric vehicle.

### BRIEF DESCRIPTION OF THE DRAWINGS

FIG. 1 illustrates a lower vehicle structure for an electric vehicle having a body-integrated vehicle battery box sub assembly.

FIG. 2 illustrates a top-down view of a lower vehicle structure for an electric vehicle having a body-integrated vehicle battery box sub assembly.

FIG. 3 illustrates a side profile view of a lower vehicle structure for an electric vehicle having a body-integrated vehicle battery box sub assembly.

FIG. 4 illustrates a front profile view of a lower vehicle structure for an electric vehicle having a body-integrated vehicle battery box sub assembly.

FIG. 5 illustrates a rear profile view of a lower vehicle structure for an electric vehicle having a body-integrated vehicle battery box sub assembly.

FIG. 6 illustrates a passenger compartment structure for an electric vehicle having a body-integrated vehicle battery box sub assembly.

FIG. 7 illustrates an exploded view of a passenger compartment structure for an electric vehicle having a body-integrated vehicle battery box sub assembly.

FIG. 8 illustrates a battery box sub assembly for integration in an electric vehicle.

FIG. 9 illustrates an exploded view of a battery box sub assembly for integration in an electric vehicle.

FIG. 10 illustrates a battery box sub assembly for integration in an electric vehicle.

FIG. 11 illustrates a front casting for a body-integrated vehicle battery box sub assembly.

FIG. 12 illustrates a cross-section of a front casting and thermal management plate for a body-integrated vehicle battery box sub assembly.

FIG. 13 illustrates a battery cell module for an electric vehicle having a body-integrated vehicle battery box sub assembly.

FIG. 14 illustrates a battery cell module installed in a battery box sub assembly for integration in an electric vehicle.

FIG. 15 illustrates an implementation for thermal management using a body-integrated vehicle battery box sub assembly.

FIG. 16 illustrates an operation for thermal management using a body-integrated vehicle battery box sub assembly.

FIG. 17 illustrates a computing system for performing thermal management using a body-integrated vehicle battery box sub assembly.

### DETAILED DESCRIPTION

In a traditional skateboard architecture for a vehicle, battery modules are installed into a casing, referred to as a battery box, to form a battery pack before the assembled pack is installed into the vehicle (usually from the underside of the vehicle) and secured by mechanical means, such as bolting the box into the chassis of the vehicle. The battery box described below is a sub assembly of the vehicle body structure. The sub assembly creates volume in the vehicle into which battery modules can be installed improving volumetric efficiency for battery packaging. Structure within the volume of the battery box is also part of the vehicle structure as whole, which improves overall structural rigidity and safety of the fully assembled vehicle. The battery box sub assembly further reduces overall mass, complexity, and cost of vehicle production, whilst improving service access after final assembly. For instance, a thermal management plate may both regulate battery temperature and act as a floor for the vehicle passenger/utility compartment of the vehicle.

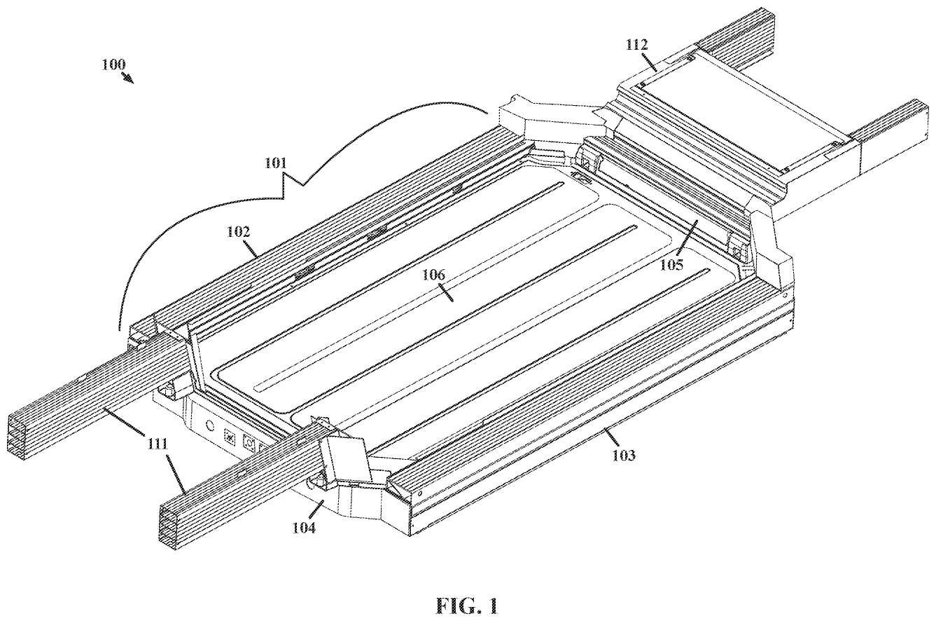

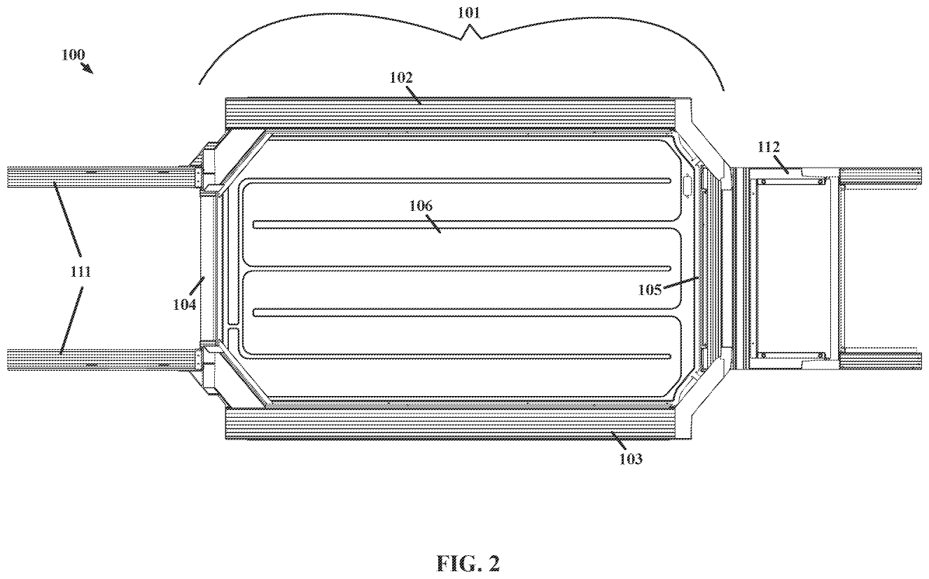

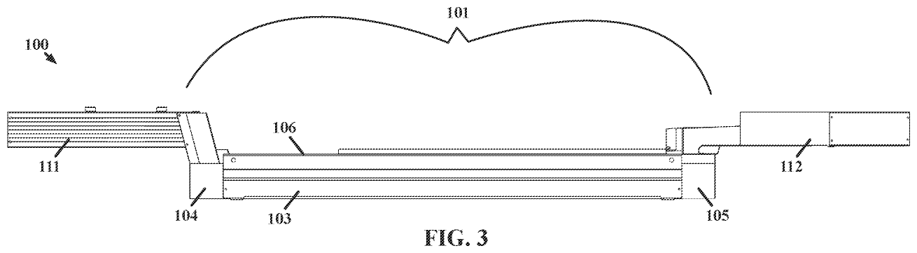

FIG. 1 illustrates lower vehicle structure 100 for an electric vehicle having a body-integrated vehicle battery box sub assembly. FIG. 2 illustrates a top-down view of lower vehicle structure 100 and FIG. 3 illustrates a side profile view of lower vehicle structure 100. Lower vehicle structure 100 is a lower structure of a vehicle upon which additional vehicle structure, such as structure for a passenger or cargo compartment, may be built. Lower vehicle structure 100 may be structure for a car, truck, van, bus, locomotive, or any other type of electric powered vehicle. Lower vehicle structure 100 includes left side sill 102, right side sill 103, front casting 104, rear casting 105, and thermal management plate 106, which form battery box sub assembly 101. Battery box sub assembly 101 is a component of the structure for the vehicle having lower vehicle structure 100. Components 102-106 of battery box sub assembly 101 may be welded, adhesively bonded, bolted, riveted, or attached to one another by other attachment mechanisms-including combinations thereof. The volume surrounded by side sills 102-103 and castings 104-105 and capped by thermal management plate 106 is a cavity where battery cell modules may be installed. Thermal management plate 106 includes one or more channels throughout to direct the flow of fluid to cool and/or heat the battery cell modules. The channels are likely unidirectional in that the fluid only flows one direction through a channel but there may be examples where the flow direction may switch. The curving channel arrangement of the channel shown in this example is merely one possible channel configuration. Thermal management plate 106 may further be used as a floor of the vehicle's interior. This reduced vehicle complexity and mass by not requiring an additional floor element above the battery pack assembly. Also, using thermal management plate 106 as the vehicle floor may enable heat to be exchanged between thermal management plate 106 and the vehicles interior, which may unlock even more efficiency for the electric vehicle.

Left side sill 102 and right side sill 103 may be manufactured by extrusion, a process where a solid metal (e.g., aluminum) billet is heated and forced through a die creating the desired shape. Front casting 104 and rear casting 105 may be manufactured using a metal casting process, as implied by their name. However, other methods of manufacture (e.g., milling or combining multiple laser cut and folded panels) may be used to create the side sills or castings. Likewise, materials other than metal (e.g., composites) may be used instead for the components.

A battery cell module includes battery cells (e.g., cylindrical cells, pouch cells, prismatic cells, etc.) and connections, such as wires and busbars, creating an electrical circuit with the cells. A module may also include monitoring and control systems that keep track of individual cell health, voltage, and temperature, ensuring safe and efficient operation, and safety components like fuses and pressure relief vents to mitigate potential hazards in case of cell failure. Traditionally, a battery module may also include cell thermal management (i.e., cooling and/or heating) components, such as hoses, connectors, valves, etc. for fluid to flow to warm or cool the cells therein. Battery cells have an optimal temperature range for operation and may require cooling or heating to remain within that optimal temperature range. For instance, when charging, cells will heat up and may require cooling to prevent heat from damaging the cells or, when it is cold outside, the cells may require heating to discharge their power most effectively. Battery box sub assembly 101 includes thermal management plate 106 to obviate the need for thermal management inside the modules. Modules without internal thermal management are less complex and less costly to manufacture while also removing a potential point of failure within the modules. In some examples, the modules may still include thermal management components, or the modules may otherwise not require thermal management provided by thermal management plate 106. In those examples, thermal management plate 106 may be replaced with a simpler plate that does not include channels for fluid.

In this example, battery box sub assembly 101 includes front body structure 111 affixed to front casting 104 and rear body structure 112 affixed to rear casting 105. Front body structure 111 is affixed at its rear to front casting 104 and rear body structure 112 is affixed at its front to rear casting 105. The brackets may be attached to the castings or may be formed into the castings, and the body structures may be attached to the brackets, via welding, adhesive bonding, bolts, rivets, or some other attachment means. The body structures may be attached to the brackets using similar attachment means. Attachment mechanisms other than brackets may be used in other examples. For instance, front body structure 111 and rear body structure 112 may be welded or adhesively bonded directly to front casting 104 and rear casting 105, respectively. In this example, front body structure 111 and rear body structure 112 each include two rails, often referred to as longitudinals, that run parallel to the length of the vehicle. Front body structure 111 and rear body structure 112 may provide front and rear impact absorption for the vehicle as well as provide places to mount vehicle components (e.g., subframes, suspension components, electric traction motors, body panels, bumpers, etc.). The front and rear body structures may take different forms in other vehicles.

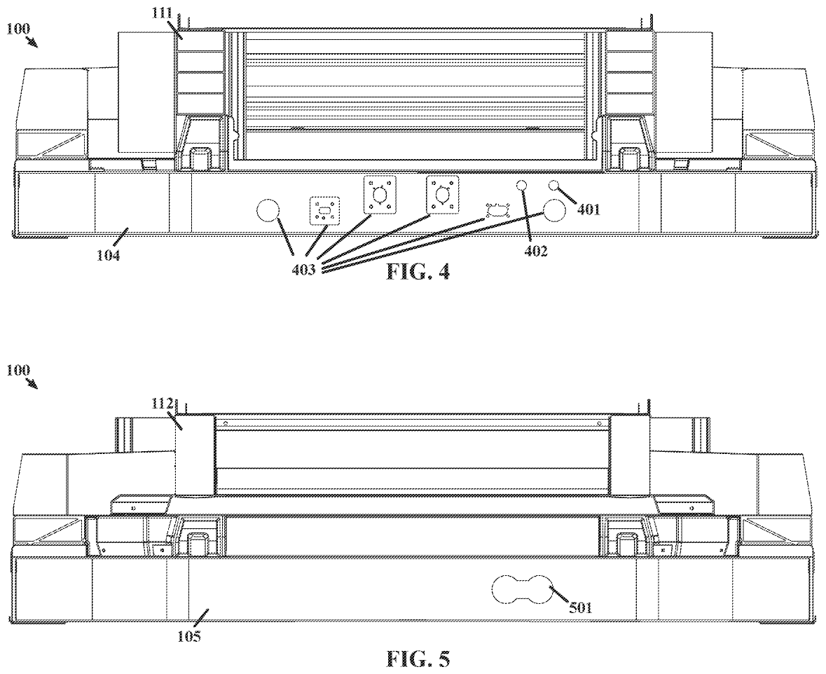

FIG. 4 illustrates a front profile view of lower vehicle structure 100 for an electric vehicle having a body-integrated vehicle battery box sub assembly. From this view, openings in front casting 104 can be seen with front body structure 111 affixed above front casting 104. Fluid input 401 is an input through which cooling/heating fluid, often referred to simply as coolant, passes to reach thermal management plate 106. The coolant may be an ethylene glycol solution, a refrigerant chemical, water, etc. Fluid output 402 is an output through which coolant passes to return from thermal management plate 106 after flowing through the channels therein. Fluid input 401 and fluid output 402 may include hydraulic connectors to which hoses are attached. A heat exchanger for the vehicle may warm or cool the coolant returning to the heat exchanger from fluid output 402 before the coolant is pumped into fluid input 401. Fluid input 401 and fluid output 402 may be omitted in examples where the thermal management of thermal management plate 106 is not needed.

In this example, additional ports 403 exist in front casting 104 to provide connections through front casting 104 to the battery modules within battery box sub assembly 101. Additional ports 403 may include inlets/outlets for high-voltage electrical wires for a high-voltage circuit to power one or more traction motors of the vehicle, charge the battery cells, or power other high-voltage components of the vehicle. Additional ports 403 may include inlets/outlets for low-voltage wires for a low-voltage circuit to power control systems for the battery modules in battery box sub assembly 101. Likewise, additional ports 403 may include openings for wires carrying control signals exchanged between the battery modules and a vehicle compute unit tasked with managing the battery modules. Additional ports 403 may further include pressure control valves to ensure the pressure within battery box sub assembly 101, when sealed, is maintained within safe levels. Many of additional ports 403 may be included in traditional battery boxes and front casting 104 also includes additional ports 403 to ensure proper functionality while still acting as a structural member of the vehicle.

FIG. 5 illustrates a rear profile view of lower vehicle structure 100 for an electric vehicle having a body-integrated vehicle battery box sub assembly. From this view, rear casting 105 is seen with rear body structure 112 affixed above it. Rear casting 105 does not include all the same ports as front casting 104 in this example, as only high-voltage inlet/outlet 501 is shown but may not be included in other examples. However, in other examples, rear casting 105 may include at least a portion of the ports. For example, if the vehicle is equipped with a rear traction motor, rear casting 105 may include a fluid output from which fluid can flow from thermal management plate 106 to the rear traction motor for thermal management of the motor and back to thermal management plate 106 through a fluid input in rear casting 105. Similarly, control ports may be included to control the rear traction motor.

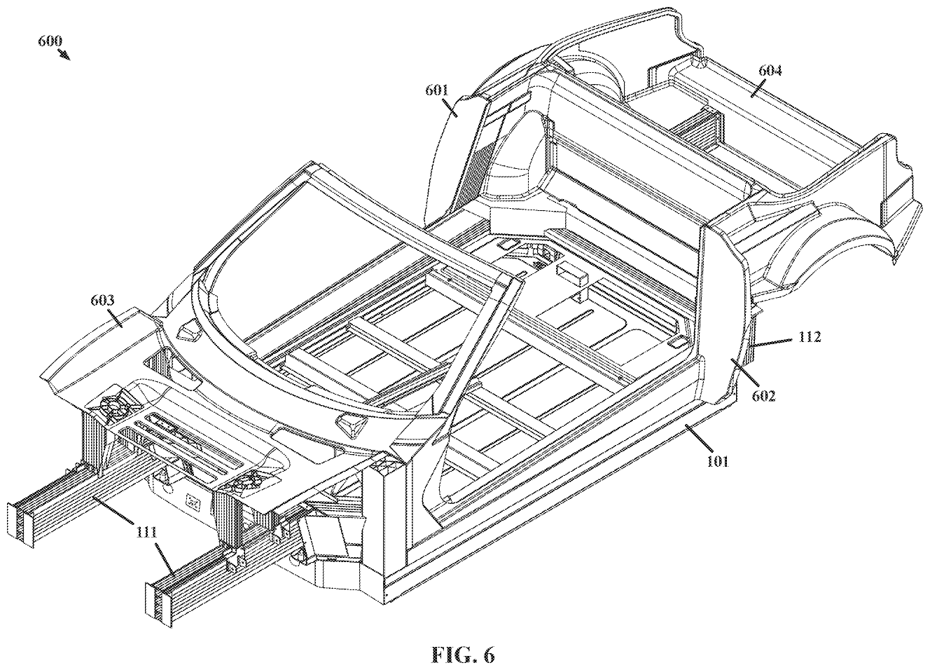

FIG. 6 illustrates passenger compartment structure 600 for an electric vehicle having a body-integrated vehicle battery box sub assembly. Passenger compartment structure 600 includes right side body structure 601, left side body structure 602, front passenger body structure 603, and rear passenger body structure 604 affixed to battery box sub assembly 101. In this example, front body structure 111 is a component of front passenger body structure 603 and rear body structure 112 is a component of rear passenger body structure 604. Like front body structure 111 and rear body structure 112, additional body components 601-604 may be adhesively bonded, welded, bolted, riveted, or otherwise affixed to form the body structure of passenger compartment structure 600. Passenger compartment structure 600 is merely an exemplary body structure. Other examples may include additional pillars and a roof in the body structure. Passenger compartment structure 600 predominantly shows body structure surrounding a passenger compartment of the vehicle. Rear passenger body structure 604 also, at least partially, forms a cargo area for the vehicle in this example. The body structure in other examples may be for any type of vehicle, such as sedan, wagon, truck, convertible, etc., with different shaped body structure components affixed to battery box sub assembly 101 depending on the desired vehicle type.

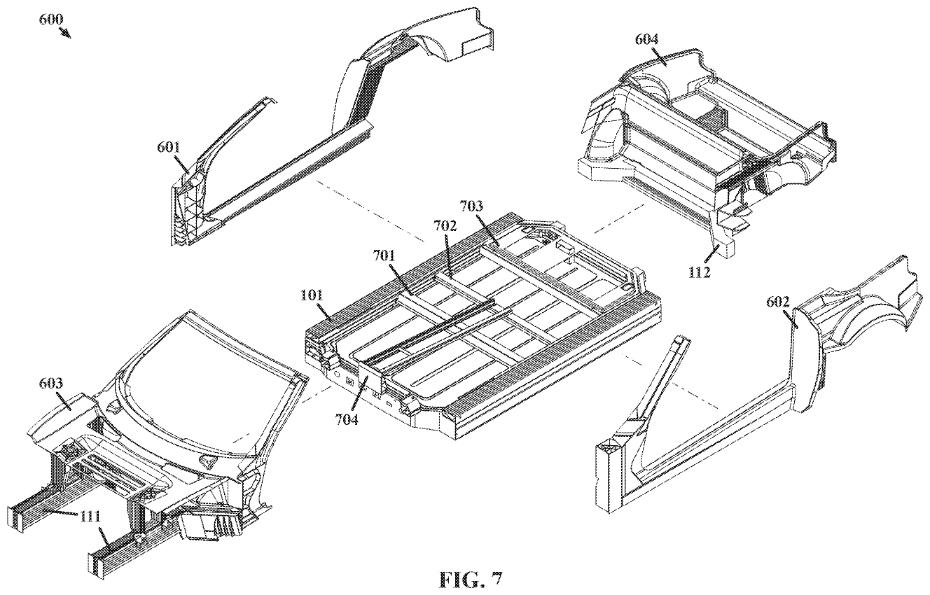

FIG. 7 illustrates an exploded view of passenger compartment structure 600 for an electric vehicle having a body-integrated vehicle battery box sub assembly. The exploded view shows components 111-112 and 601-604 when not attached to battery box sub assembly 101 and each other. The exploded view also shows structural crossmembers 701-703 spanning side sills 102-103 above thermal management plate 106. Structural crossmembers 701-703 may be affixed to the side sills in a manner similar to front body structure 111 and rear body structure 112. Structural crossmembers 701-703 may also be adhesively bonded to thermal management plate 106 to enhance structural strength and rigidity. In this example, not only do structural crossmembers 701-703 provide additional structural support for the vehicle, structural crossmembers 701-703 provide mounting points for interior components, such as seats and consoles. For example, riser 704 may be attached to structural crossmember 702 at one end and front casting 104 at the other to provide a frame in which center console components for the vehicle may be mounted. Since thermal management plate 106 is also the floor of passenger compartment structure 600, it would otherwise be difficult to mount interior components to thermal management plate 106 without compromising the thermal management functionality of thermal management plate 106 or the performance of battery modules in the cavity under thermal management plate 106. Interior components, such as insulation material, carpeting, etc. may be installed directly onto thermal management plate 106 to finish the vehicles interior.

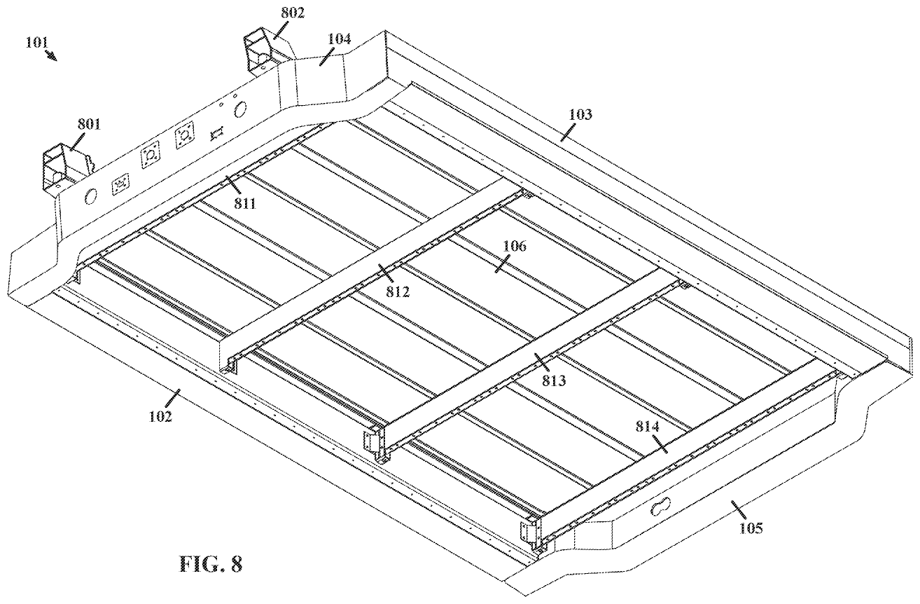

FIG. 8 illustrates battery box sub assembly 101 for integration in an electric vehicle. Battery box sub assembly 101 is shown from the underside with the cavity open. Brackets 801-802 are part of front casting 104 (i.e., casted with the rest of front casting 104) for mounting front body structure 111 in this example but may be omitted in others. Crossmembers 811-814 span the cavity between left side sill 102 and right side sill 103. Crossmembers 811-814 may be connected to left side sill 102 and right side sill 103 using structural adhesive, welding, bolts, rivets, or some other attachment mechanism. Crossmembers 811-814 provide structural rigidity to the cavity of battery box sub assembly 101, impact absorption for side impacts to the vehicle, and mounting points for battery modules installed in the cavity. While this example includes four crossmembers, the number, size, shape, and spacing of the crossmembers may depend on desired structural rigidity, a number of battery modules being installed, a size of the modules, or some other packaging consideration.

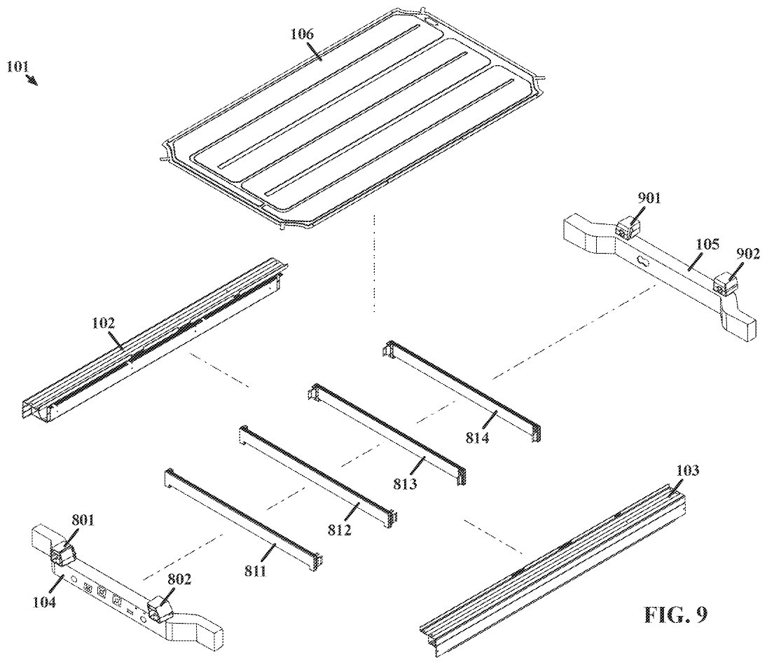

FIG. 9 illustrates an exploded view of battery box sub assembly 101 for integration in an electric vehicle. In this exploded view, brackets 901-902 can be seen as part of rear casting 105 for mounting rear body structure 112 in this example but may be omitted in others. Likewise, brackets 801-802 are shown as part of front body structure 111.

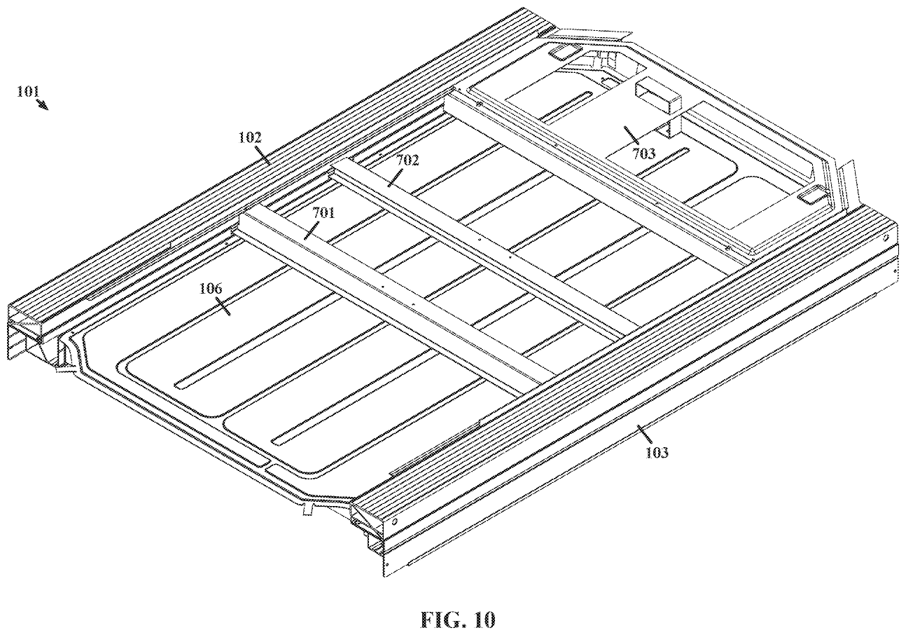

FIG. 10 illustrates battery box sub assembly 101 for integration in an electric vehicle. In this example, front casting 104 and rear casting 105 are omitted to show the inner design of left side sill 102 and right side sill 103. Structure inside left side sill 102 and right side sill 103 is configured to provide structural rigidity and impact absorption. The exact configuration may differ depending on desired characteristics for rigidity and impact absorption. For example, side sills 102-103 may each include a combination of multiple extrusions, such as a high strength inner extrusion to protect the battery modules and a lower strength, deformable outer extrusion that absorbs impact forces. A metal extrusion process may be employed to achieve the desired interior configuration for left side sill 102 and right side sill 103.

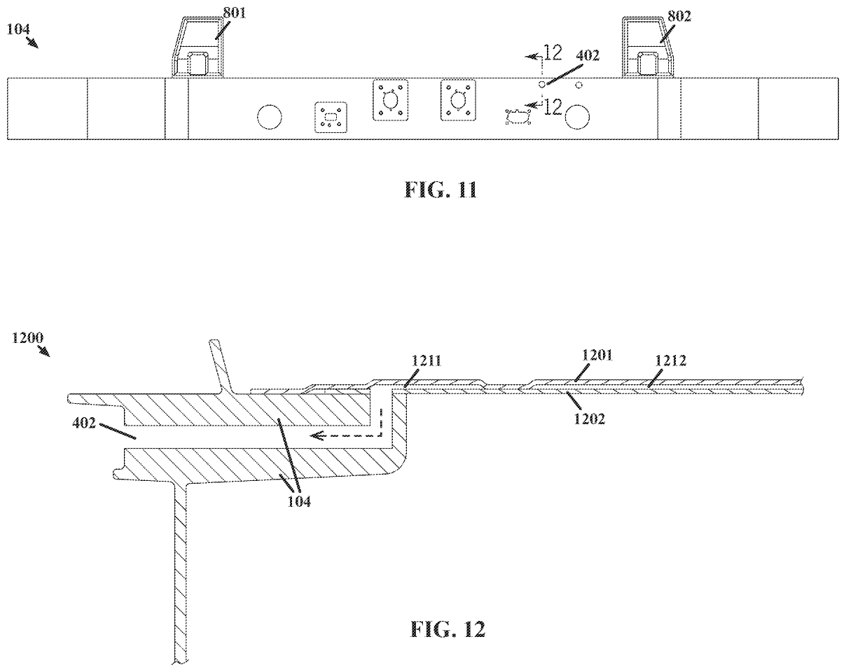

FIG. 11 illustrates front casting 104 for a body-integrated vehicle battery box sub assembly 101. Brackets 801-802 are part of front casting 104 for mounting front body structure 111 in this example but may be omitted in others. A cross-section illustrated in FIG. 12 is shown at fluid output 402 in front casting 104.

FIG. 12 illustrates cross-section 1200 of front casting 104 and thermal management plate 106 for a body-integrated vehicle battery box sub assembly 101. Specifically, the cross-section is at the location of fluid output 402 in front casting 104 and shows how coolant may flow from thermal management plate 106. Thermal management plate 106 in this example includes upper pressing 1201 and lower pressing 1202. A pressing may be produced from stamping a desired shape out of sheet metal. Upper pressing 1201 and lower pressing 1202 may be connected at their perimeter using adhesive, welding, rivets, or some other type of attachment mechanism. In this example, upper pressing 1201 and lower pressing 1202 are substantially the same size with upper pressing 1201 overlapping lower pressing 1202 a small amount where thermal management plate 106 is affixed to front casting 104. A similar overlap may exist around the entire perimeter of thermal management plate 106.

In this case, lower pressing 1202 is substantially flat to promote contact for thermal conductivity with battery modules installed in the cavity of battery box sub assembly 101. Upper pressing 1201 is not flat, which enables portions of upper pressing 1201 to contact lower pressing 1202. This leaves space including gap 1211 and gap 1212 to form a unidirectional channel for fluid to flow through thermal management plate 106. The size of the gaps may depend upon desired cooling properties of thermal management plate 106, which may depend on characteristics of battery modules installed into battery box sub assembly 101. Thermal management plate 106 may rely on contact between upper pressing 1201 and lower pressing 1202 between gaps to maintain the fluid within the channel or an adhesive, sealant, or other type of barrier may be used to ensure the fluid stays within the channel. While the two components of thermal management plate 106 in this example are produced by pressing, other methods of manufacture may be used instead. For example, the channel may be created by milling the channel out of a sheet of metal or metal may be cast into a shape having the channel. In those examples, lower pressing 1202 may remain flat on the bottom side for contact with battery modules while allowing for the upper side of lower pressing 1202 to be shaped with the channel.

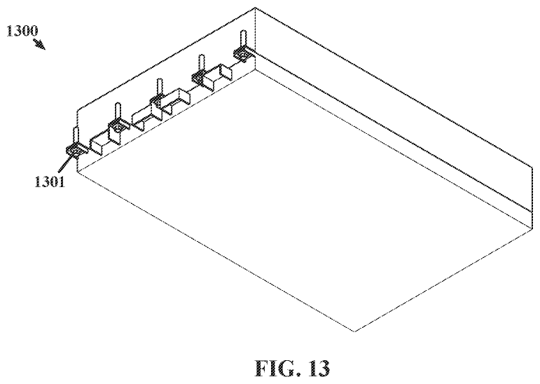

FIG. 13 illustrates battery cell module 1300 for an electric vehicle having a body-integrated vehicle battery box sub assembly. Battery cell module 1300 includes battery cells within an outer casing, likely formed from metal but other materials, such as plastic or composites, may be used. The battery cells may be connected in series, parallel, or some combination thereof depending on the power supply characteristics desired for the vehicle. While not shown, battery cell module 1300 also includes ports for high-voltage conductors (e.g., wires and/or busbars) connected to the cells within and to other battery cell modules installed in battery box sub assembly 101. Like the cells inside, the battery modules may be connected in series, parallel, or some combination thereof. Electrical power from the battery modules may then pass through high-voltage connectors in additional ports 403 of front casting 104 to a traction motor or other high-voltage components of the vehicle. The casing of battery cell module 1300 includes tabs through which bolts 1301 pass for securing battery cell module 1300 into battery box sub assembly 101. While not shown, other sides of battery cell module 1300 may also include tabs for bolts 1301. Other types of fasteners may also be used but a type of fastener enabling removal of battery cell module 1300 from battery box sub assembly 101 is preferred since battery box sub assembly 101 is an integral part of the vehicle body assembly and cannot simply be removed like traditional battery packs.

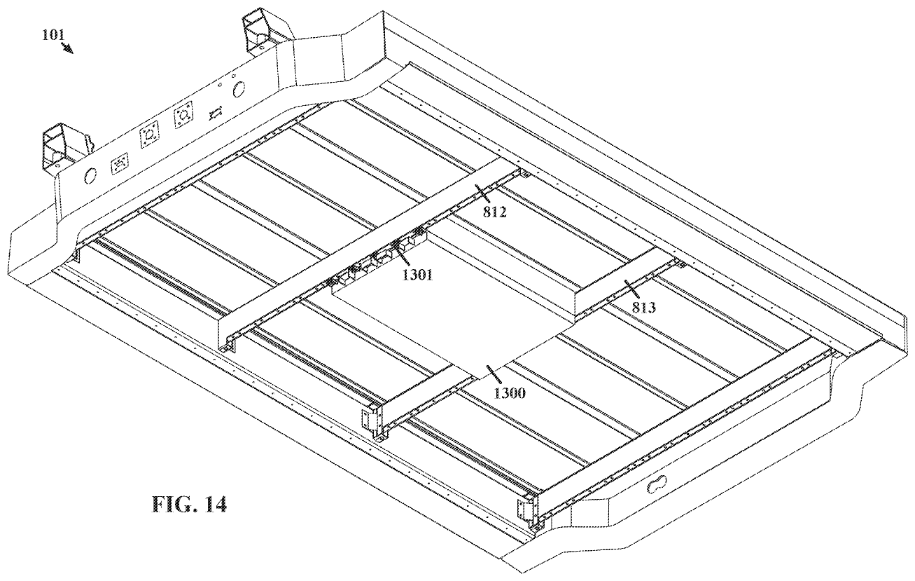

FIG. 14 illustrates battery cell module 1300 installed in battery box sub assembly 101 for integration in an electric vehicle. In this example, the cavity within battery box sub assembly 101 has room for three rows of three battery cell modules. Battery cell module 1300 is shown bolted into the middle position of the middle row with room for up to eight additional modules within battery box sub assembly 101. In this example, battery cell module 1300 is bolted to crossmember 812 and crossmember 813, which include threaded holes to accept bolts 1301. Battery cell module 1300 may be lifted into the position from under the vehicle before being secured using bolts 1301. A lower plate, sized to cover the bottom of the cavity for the battery cell modules may be installed onto battery box sub assembly 101 to protect the battery cell modules from the elements and road hazards. Preferably, the lower plate is affixed by mechanical fasteners like bolts 1301 to enable the removal of the lower plate should something within battery box sub assembly 101 require servicing. A gasket or other mechanism for sealing the cavity may be used around the perimeter of the lower plate where the lower plate contacts side sills 102-103 and castings 104-105. Excess adhesive, expanding foam, or other sealer may also be used to ensure battery box sub assembly 101 is sealed where side sills 102-103 and castings 104-105 meet each other. In some examples, especially those where ease of service is not a big concern, the lower plate may be welded (e.g., using laser or arc welding) to seal the cavity of battery box sub assembly 101 but would require additional effort (such as grinding) to remove for servicing the battery pack.

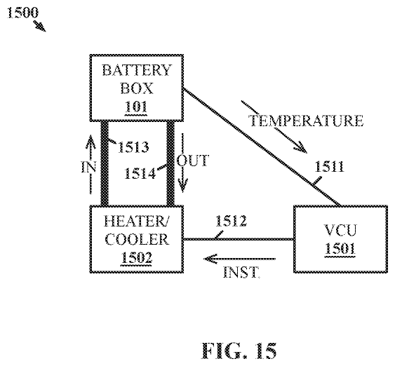

FIG. 15 illustrates implementation 1500 for thermal management using a body-integrated vehicle battery box sub assembly. Implementation 1500 includes battery box sub assembly 101, vehicle compute unit (VCU) 1501, and heater/cooler system 1502. Battery box sub assembly 101 and VCU 1501 communicate over communication link 1511. VCU 1501 and heater/cooler system 1502 communicate over communication link 1512. Communication links 1511-1512 may be direct links or may include intervening systems, networks, or devices.

VCU 1501 is a processor-based computing system that is at least tasked with controlling thermal management of battery cells within battery box sub assembly 101. VCU 1501 may handle other vehicle tasks as well. VCU 1501 includes a communication interface for communication links 1511-1512. The communication interface may also handle other communication links with VCU 1501. VCU 1501 may also include circuitry for connecting to sensors or other types of vehicle components (e.g., buttons, other motors, other displays, driver assistance systems, etc.). In some examples, VCU 1501 may be one of multiple VCUs that each handle at least a portion of the tasks for a vehicle.

In this example, heater/cooler system 1502 handles the heating and cooling of coolant to manage the thermal conditions of battery box sub assembly 101. Heater/cooler system 1502 may include one or more pumps for cycling fluid to battery box sub assembly 101 via hydraulic tubing 1513 and back from battery box sub assembly 101 via hydraulic tubing 1514. Heater/cooler system 1502 may include one or more radiators, heat exchangers, heat pumps, refrigerant compressors, resistive heating elements, or some other mechanism for heating or cooling coolant.

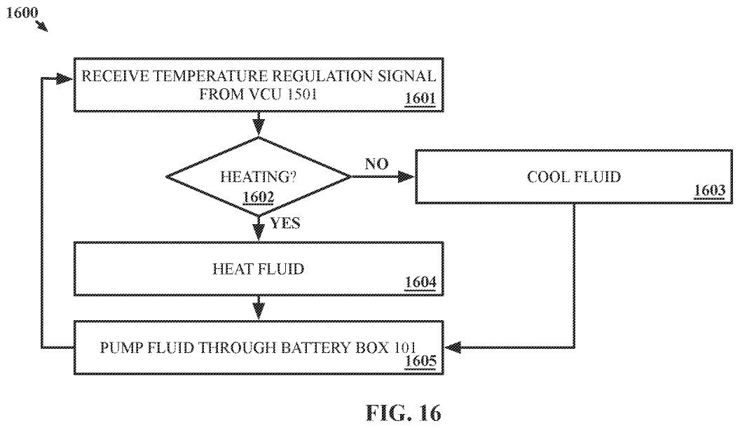

FIG. 16 illustrates operation 1600 for thermal management using a body-integrated vehicle battery box sub assembly. In operation 1600, heater/cooler system 1502 receives a temperature regulation signal from VCU 1501 (step 1601). The temperature regulation signal indicates whether coolant should be heated or cooled before being cycled back through battery box sub assembly 101. VCU 1501 may receive temperature information from sensors in battery box sub assembly 101. For example, each battery cell module may include one or more temperature sensors to monitor temperature of the battery cells therein and send information to VCU 1501. If the temperature information indicates the temperature is greater than a threshold temperature, then VCU 1501 may direct heater/cooler system 1502 to cool the coolant with the temperature regulation signal. If the temperature information indicates the temperature is lower than a threshold temperature (likely different than the above threshold to avoid constant switching between heating and cooling), then VCU 1501 may direct heater/cooler system 1502 to heat the coolant with the temperature regulation signal. In some examples, heater/cooler system 1502 may be configured to only perform one function (i.e., heating or cooling but not both) and, in those examples, only one threshold may be used. Although, in further examples, different levels of heating and cooling may be used as indicated by different thresholds. For instance, more aggressive cooling may be ordered by VCU 1501 if the temperature information indicates a higher threshold has been exceeded (e.g., during fast charging) than a lower threshold (e.g., one that might be reached during normal summertime driving).

Upon receiving the temperature regulation signal, heater/cooler system 1502 determines whether the signal is directing heater/cooler system 1502 to heat or cool the coolant fluid (step 1602). In some examples, a signal may direct heater/cooler system 1502 to do nothing (or to stop heating or cooling) if the battery temperature is already in a desired temperature range or heater/cooler system 1502 may infer that no temperature correction is needed if it is not receiving a temperature regulation signal. If the temperature regulation signal directs heater/cooler system 1502 to cool the coolant fluid, heater/cooler system 1502 cools the fluid (step 1603). The amount in which the coolant gets cooled may depend on the temperature of the coolant prior to cooling (e.g., the temperature of the coolant when received from battery box sub assembly 101 via hydraulic tubing 1514), an amount of cooling requested by VCU 1501, the cooling capabilities of heater/cooler system 1502, or some other factor. If the temperature regulation signal directs heater/cooler system 1502 to heat the coolant fluid, heater/cooler system 1502 heats the fluid (step 1604). Like cooling the fluid, the amount in which the coolant gets heated may depend on the temperature of the coolant prior to heating, an amount of heating requested by VCU 1501, the heating capabilities of heater/cooler system 1502, or some other factor. After being heated or cooled, heater/cooler system 1502 pumps the coolant through battery box sub assembly 101 via hydraulic tubing 1513 (step 1605).

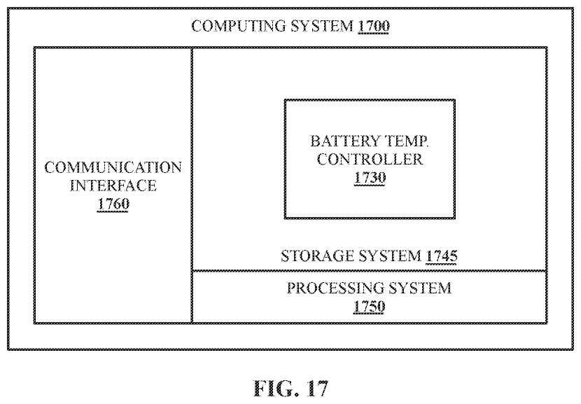

FIG. 17 illustrates computing system 1700 for performing thermal management using a body-integrated vehicle battery box sub assembly. Computing system 1700 is an example architecture for VCU 1501. Computing system 1700 includes storage system 1745, processing system 1750, and communication interface 1760. Processing system 1750 is operatively linked to communication interface 1760 and storage system 1745. Communication interface 1760 may be communicatively linked to storage system 1745 in some implementations. Computing system 1700 may further include other components such as a battery and enclosure that are not shown for clarity.

Communication interface 1760 comprises components that communicate over communication links, such as network cards, ports, radio frequency (RF), processing circuitry and software, or some other communication devices. Communication interface 1760 may be configured to communicate over metallic, wireless, or optical links. Communication interface 1760 may be configured to use Time Division Multiplex (TDM), Internet Protocol (IP), Ethernet, optical networking, wireless protocols, communication signaling, or some other communication format—including combinations thereof.

Processing system 1750 comprises microprocessor and other circuitry that retrieves and executes operating software from storage system 1745. Storage system 1745 may include volatile and nonvolatile, removable, and non-removable media implemented in any method or technology for storage of information, such as computer readable instructions, data structures, program modules, or other data. Storage system 1745 may be implemented as a single storage device but may also be implemented across multiple storage devices or sub-systems. Storage system 1745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no examples would storage media of storage system 1745, or any other computer-readable storage medium herein, be considered a transitory form of signal transmission (often referred to as “signals per se”), such as a propagating electrical or electromagnetic signal or carrier wave.

Processing system 1750 is typically mounted on a circuit board that may also hold the storage system. The operating software of storage system 1745 comprises computer programs, firmware, or some other form of machine-readable program instructions. The operating software of storage system 1745 comprises battery temperature controller 1730. The operating software on storage system 1745 may further include an operating system, utilities, drivers, network interfaces, applications, or some other type of software. When read and executed by processing system 1750 the operating software on storage system 1745 directs computing system 1700 to control a motor that rotates a display system. Battery temperature controller 1730 may execute natively on processing system 1750 or the operating software may include virtualization software, such as a hypervisor, to virtualize computing hardware on which battery temperature controller 1730 executes.

In an example, battery temperature controller 1730 directs processing system 1750 to determine that a heater/cooler system should heat or cool a battery box sub assembly and instruct the heater/cooler system to heat or cool the coolant fluid before feeding coolant fluid into an inlet of a front casting of the battery box sub assembly. The heater/cooler system receives the coolant fluid from an outlet of the front casting after flowing through the thermal management plate.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An apparatus for a battery box sub assembly for a vehicle, the apparatus comprising:
a left side sill for the vehicle;
a right side sill for the vehicle;
a front casting affixed to a front end of the left side sill and a front end of the right side sill;
a rear casting affixed to a rear end of the left side sill and a rear end of the right side sill, wherein the left side sill, the right side sill, the front casting, and the rear casting form a cavity into which one or more battery modules fit; and
a thermal management plate positioned on top of the cavity.

2. The apparatus of claim 1, wherein the thermal management plate forms an interior floor of the vehicle.

3. The apparatus of claim 1, comprising:
a front portion of a rear body structure of the vehicle affixed to the rear casting; and
a rear portion of a front body structure of the vehicle affixed to the front casting.

4. The apparatus of claim 1, wherein the thermal management plate comprises:
an upper pressing; and
a lower pressing, wherein one or more channels for liquid are formed in space between where the upper pressing and the lower pressing meet.

5. The apparatus of claim 1, comprising:
one or more crossmembers spanning between the left side sill and the right side sill in the cavity.

6. The apparatus of claim 1, wherein the front casting includes:
an inlet through which liquid passes to reach the thermal management plate; and
an outlet through which the liquid passes returning from the thermal management plate.

7. The apparatus of claim 1, wherein the rear casting includes:
an outlet through which liquid passes from the thermal management plate to cool a rear traction motor of the vehicle; and
an inlet through which the liquid passes to reach the thermal management plate when returning from the rear traction motor.

8. The apparatus of claim 1, comprising:
the one or more battery modules inserted into the cavity, wherein the one or more battery modules are mechanically affixed to one or more crossmembers spanning between the left side sill and the right side sill in the cavity.

9. The apparatus of claim 8, comprising:
a thermally conductive material between the one or more battery modules and the thermal management plate.

10. The apparatus of claim 1, wherein the front casting includes:
an inlet for a high-voltage electrical circuit of the one or more battery modules; and
an outlet for the high-voltage electrical circuit, wherein the high-voltage electrical circuit powers one or more electric traction motors of the vehicle.

11. The apparatus of claim 1, wherein the front casting includes:
an inlet for a low-voltage electrical circuit powering low-voltage components of the one or more battery modules; and
an outlet for the low-voltage electrical circuit.

12. The apparatus of claim 1, wherein the front casting includes:
an opening for control signals exchanged with the one or more battery modules.

13. The apparatus of claim 1, wherein one or more of the front casting and the rear casting includes:
a pressure relief valve for the cavity.

14. The apparatus of claim 1, comprising:
a protective plate positioned below the cavity to protect the one or more battery modules.

15. A method for managing temperature of one or more battery modules for a vehicle, the method comprising:
feeding coolant fluid into an inlet of a front casting of a battery box sub assembly for the vehicle, wherein the battery box sub assembly includes:
a left side sill for the vehicle,
a right side sill for the vehicle,
the front casting affixed to a front end of the left side sill and a front end of the right side sill,
a rear casting affixed to a rear end of the left side sill and a rear end of the right side sill, wherein the left side sill, the right side sill, the front casting, and the rear casting form a cavity into which the one or more battery modules fit, and
a thermal management plate positioned on top of the cavity into which the coolant fluid flows after passing through the inlet; and
receiving the coolant fluid from an outlet of the front casting after flowing through the thermal management plate.

16. The method of claim 15, comprising:
after receiving the coolant fluid, adjusting a temperature of the coolant fluid depending on a temperature requirement for the one or more battery modules; and
feeding the coolant fluid back into the inlet of the front casting.

17. The method of claim 15, comprising:
receiving the coolant fluid from an outlet of the rear casting;
feeding the coolant fluid through a rear traction motor for the vehicle;
receiving the coolant fluid from the rear traction motor; and
feeding the coolant fluid through an inlet of the rear casting into the thermal management plate.

18. An electric vehicle, comprising:
a battery box sub assembly;
a right bodyside affixed to the battery box sub assembly;
a left bodyside affixed to the battery box sub assembly;
a front body structure affixed to the battery box sub assembly; and
a rear body structure affixed to the battery box sub assembly,
wherein the battery box sub assembly forms a cavity for one or more battery modules of the electric vehicle.

19. The electric vehicle of claim 18, wherein the battery box sub assembly forms a floor of the electric vehicle.

20. The electric vehicle of claim 19, wherein the floor comprises a thermal management plate for regulating temperature of the one or more battery modules.
